(19) United States
(12) Patent Application Publication
(10) Pub. No.: US 2025/0078559 A1
(43) Pub. Date: Mar. 6, 2025

(54) MOVING BODY AUTHENTICATION SYSTEM

(71) Applicant: TOYOTA JIDOSHA KABUSHIKI KAISHA, Aichi-ken (JP)

(72) Inventors: Yuta MORI, Urayasu-shi (JP); Hitoshi KAMADA, Tokyo (JP); Takahiro IWASAKI, Tokyo (JP)

(21) Appl. No.: 18/811,773

(22) Filed: Aug. 22, 2024

(30) Foreign Application Priority Data
Aug. 28, 2023 (JP) 2023-137913

(51) Int. Cl. G06V 40/10; G06T 7/70; G06V 10/12; G06V 10/25

(52) U.S. Cl. CPC G06V 40/10; G06T 7/70; G06V 10/12; G06V 10/25; G06T 2207/30196

(57) ABSTRACT

A moving body authentication system acquires position information indicating a current position of a moving body, and selects a target camera having a predetermined level or higher of ease of authentication from among a plurality of cameras on the basis of at least the position information and a camera information. Further, the moving body authentication system authenticates the moving body based on comparison between an image by the target camera and an authentication image.

### CROSS-REFERENCE TO RELATED APPLICATION

The present application claims priority under 35 U.S.C. § 119 to Japanese Patent Application No. 2023-137913, filed on Aug. 28, 2023, the contents of which application are incorporated herein by reference in their entirety.

### BACKGROUND

### Technical Field

The present disclosure relates to a technique for authenticating a moving body.

### Background Art

JP 2017111506 A discloses a watching system. The watching system detects the watching target person based on face recognition data of the watching target person and information obtained by face recognition by a camera, and records a moving image for a certain period of time. The watching system transmits URL information for accessing the moving image to an electronic mail address of a communication terminal of the watcher.

### SUMMARY

Considered is a technology for authenticating a moving body in a predetermined area. When a plurality of cameras are present in a predetermined area, conventionally, authentication of a moving body is performed in each of camera images captured by the plurality of cameras. When authentication is performed even for a camera image that does not include a moving body to be authenticated, the processing load increases.

An object of the present disclosure is to provide a technique capable of reducing a processing load when a moving body is authenticated in a predetermined area.

An aspect of the present disclosure relates to a moving body authentication system for authenticating a moving body in a predetermined area.

The moving body authentication system includes:
one or more processors configured to communicate with a plurality of cameras existing in the predetermined area; and
one or more memories configured to store an authentication image of the moving body and camera information indicating at least a position and an orientation of each of the plurality of cameras.

Ease of authentication of the moving body depends on at least a distance between the moving body and a camera, and increases as the distance becomes shorter.

When receiving a request for authenticating the moving body, the one or more processors acquire position information indicating a current position of the moving body.

The one or more processors select a target camera having the ease of authentication equal to or higher than a predetermined level from the plurality of cameras based on at least the position information and the camera information.

The one or more processors authenticate the moving body based on a comparison between an image captured by the target camera and the authentication image.

According to the present disclosure, when the request for authenticating the moving body is received, a camera satisfying a condition that the ease of authenticating the moving body is equal to or higher than the predetermined level is selected as the target camera. Then, the moving body is authenticated based on comparison between the image captured by the target camera and the authentication image. Therefore, the moving body can be authenticated with a smaller number of cameras, and the processing load is reduced. Further, since an unnecessarily large number of images are not used for authentication, the opportunity of performing unnecessary authentication processing on a person who is not related to the moving body to be authenticated is reduced. This is preferable from the viewpoint of ensuring privacy.

### BRIEF DESCRIPTION OF DRAWINGS

FIG. 1 is a diagram for explaining an outline of a moving body authentication system according to a first embodiment;

FIG. 2A is an explanatory diagram showing a specific example of a target camera selection process according to the first embodiment;

FIG. 2B is an explanatory diagram showing a specific example of a target camera selection process according to the first embodiment;

FIG. 2C is an explanatory diagram showing a specific example of a target camera selection process according to the first embodiment;

FIG. 3A is an explanatory diagram showing a specific example of an improvement process of ease of recognition according to the first embodiment;

FIG. 3B is an explanatory diagram showing a specific example of an improvement process of ease of recognition according to the first embodiment;

FIG. 3C is an explanatory diagram showing a specific example of an improvement process of ease of recognition according to the first embodiment;

FIG. 3D is an explanatory diagram showing a specific example of an improvement process of ease of recognition according to the first embodiment;

FIG. 3E is an explanatory diagram showing a specific example of an improvement process of ease of recognition according to the first embodiment;

FIG. 3F is an explanatory diagram showing a specific example of an improvement process of ease of recognition according to the first embodiment;

FIG. 4 is a flowchart showing an example of a moving body authentication process according to the first embodiment;

FIG. 5A is an explanatory diagram showing a specific example of a moving body authentication process according to a second embodiment;

FIG. 5B is an explanatory diagram showing a specific example of a moving body authentication process according to a second embodiment;

FIG. 5C is an explanatory diagram showing a specific example of a moving body authentication process according to a second embodiment;

FIG. 5D is an explanatory diagram showing a specific example of a moving body authentication process according to a second embodiment;

FIG. 6A is an explanatory diagram showing a specific example of a moving body authentication process according to a third embodiment; and

FIG. 6B is an explanatory diagram showing a specific example of a moving body authentication process according to the third embodiment.

### DESCRIPTION OF EMBODIMENT

A moving body authentication system according to an embodiment of the present disclosure will be described with reference to the accompanying drawings. In addition, the same reference numerals are given to the same elements in the drawings, and the overlapping description will be omitted.

### 1. First Embodiment

### 1-1. Outline of Moving Body Authentication System

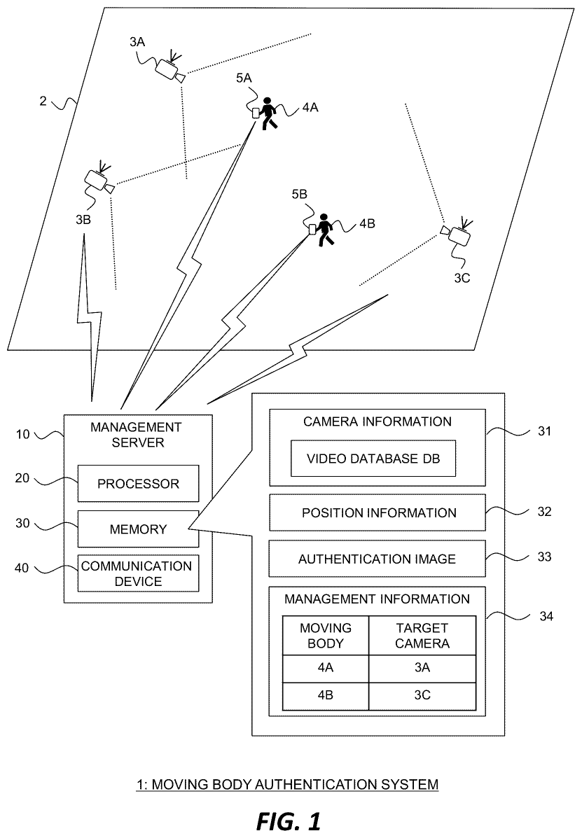

FIG. 1 is a diagram for explaining an overview of a moving body authentication system 1 according to the first embodiment. The moving body authentication system 1 authenticates a moving body 4 in a predetermined area 2. Examples of the moving body 4 (the moving body 4A, the moving body 4B, or the like) to be authenticated include humans, vehicles, animals, and the like. For example, when the moving body authentication system 1 is applied to a watching service, the moving body 4 to be authenticated is a person (for example, a child) to be watched. The predetermined area 2 is exemplified by a region, a town, a building, and the like. The request for authenticating the moving body 4 may be issued from the moving body 4 itself or may be issued from a person (for example, a parent) having a relationship with the moving body 4 (for example, a child). When the authentication request is issued from the moving body 4 itself, for example, an operation is performed from the mobile terminals 5 (the mobile terminals 5A, the mobile terminals 5B, and the like) carried by the moving body 4.

The moving body authentication system 1 includes a plurality of cameras 3 (camera 3A, camera 3B, camera 3C, and the like) existing in a predetermined area 2, and a management server 10.

The management server 10 includes one or more processors 20 (hereinafter, simply referred to as a processor 20 or processing circuitry), one or more memories 30 (hereinafter, simply referred to as a memory 30), and a communication device 40. The processor 20 executes various processes. As the processor 20, a central processing unit (CPU) is exemplified. The memory 30 stores various kinds of information necessary for processing by the processor 20. Examples of the memory 30 include a volatile memory, a nonvolatile memory, a hard disk drive (HDD), and a solid state drive (SSD). The communication device 40 can communicate with at least the plurality of cameras 3 existing in the predetermined area 2 and the mobile terminal 5 carried by the moving body 4.

The moving body authentication program (not shown) is a computer program executed by the processor 20. The processor 20 may execute the moving body authentication program to implement various functions of the management server 10. The moving body authentication program is stored in the memory 30. Alternatively, the moving body authentication program may be recorded in a computer-readable storage medium.

The various information stored in the memory 30 includes camera information 31, position information 32, and an authentication image 33.

The camera information 31 includes information on the position and orientation of each of the plurality of cameras 3 existing in the predetermined area 2. When the position and orientation of a certain camera 3 are fixed, the information is given in advance as known information. When at least one of the position and the orientation of a certain camera 3 is variable, the information is obtained by communication with the camera 3 via the communication device 40. The camera information 31 includes a video database DB in which videos (images) captured by the plurality of cameras 3 are accumulated. The video (image) captured by each camera 3 is obtained by communication with the camera 3 via the communication device 40.

The position information 32 indicates the current position of the moving body 4 to be authenticated. The current position of the moving body 4 is acquired by, for example, the GPS function of the mobile terminal 5 carried by the moving body 4. As another example, the current position of the moving body 4 may be estimated based on radio waves of a wireless LAN. The position information 32 of the moving body 4 is obtained by communication with the camera 3 via the communication device 40. The position information 32 of the moving body 4 may indicate a prediction result of the current position of the moving body 4.

The authentication image 33 is an image of a moving body 4 registered in advance for authenticating the moving body 4. For example, when the moving body 4 to be authenticated is a person, the authentication image 33 may be the face of the person. As another example, the authentication image 33 may be an entire image of the moving body 4 to be authenticated. The authentication image 33 is registered in advance by the moving body 4 itself or a person related to the moving body 4.

The outline of the moving body authentication process by the processor 20 (management server 10) according to the present embodiment is as follows. When receiving a request for authenticating the moving body 4, the processor 20 selects a “target camera” to be used for authenticating the moving body 4 from among the plurality of cameras 3. At this time, the processor 20 selects the target camera based on the “ease of authentication” of the moving body 4. The ease of authentication of the moving body 4 depends on at least the distance between the moving body 4 and the camera 3. As the distance between the moving body 4 and the camera 3 becomes shorter, the ease of authentication of the moving body 4 increases. The ease of authentication of the moving body 4 will be described in detail later. The processor 20 acquires the position information 32 and the camera information 31. Further, the processor 20 selects a target camera having a predetermined level or higher of ease of authentication from the plurality of cameras 3 based on at least the position information 32 and the camera information 31. Then, the processor 20 performs authentication of the moving body 4 based on comparison between the image captured by the target camera and the authentication image 33 of the moving body 4.

The management information 34 is information used for managing the moving body authentication process. For example, the management information 34 indicates a correspondence relationship between the moving body 4 and the target camera used for authentication of the moving body 4. Management information 34 is also stored in the memory 30. In the example illustrated in FIG. 1, the camera 4A is selected as the target camera used for the authentication of the moving body 3A, and the camera 4B is selected as the target camera used for the authentication of the moving body 3C.

As described above, according to the present embodiment, when a request to authenticate the moving body 4 is received, the camera 3 whose ease of authenticating the moving body 4 is equal to or higher than a predetermined level is selected as the “target camera”. Then, the moving body 4 is authenticated based on the comparison between the image captured by the target camera and the authentication image 33. This allows the moving body 4 to be authenticated with a smaller number of cameras, and thus the processing load is reduced. Further, since an unnecessarily large number of images are not used for authentication, the opportunity of performing unnecessary authentication processing on a person unrelated to the moving body 4 to be authenticated is reduced. This is preferable from the viewpoint of ensuring privacy.

### 1-2. Example of Selection of Target Camera

The management server 10 selects a target camera from among the plurality of cameras 3 based on the ease of authentication of the moving body 4. The ease of authentication of the moving body 4 depends on at least the distance between the moving body 4 and the camera 3. As the distance between the moving body 4 and the camera 3 becomes shorter, the ease of authentication of the moving body 4 increases. Therefore, the management server 10 may select one of the plurality of cameras 3 that is closest to the moving body 4 as the target camera. More specifically, the management server 10 calculates the distance between the moving body 4 and each camera 3 based on the camera information 31 and the position information 32 of the moving body 4. Then, the management server 10 may select the camera 3 having the shortest distance as the target camera.

In addition to the distance between the moving body 4 to be authenticated and the camera 3, other parameters may be considered.

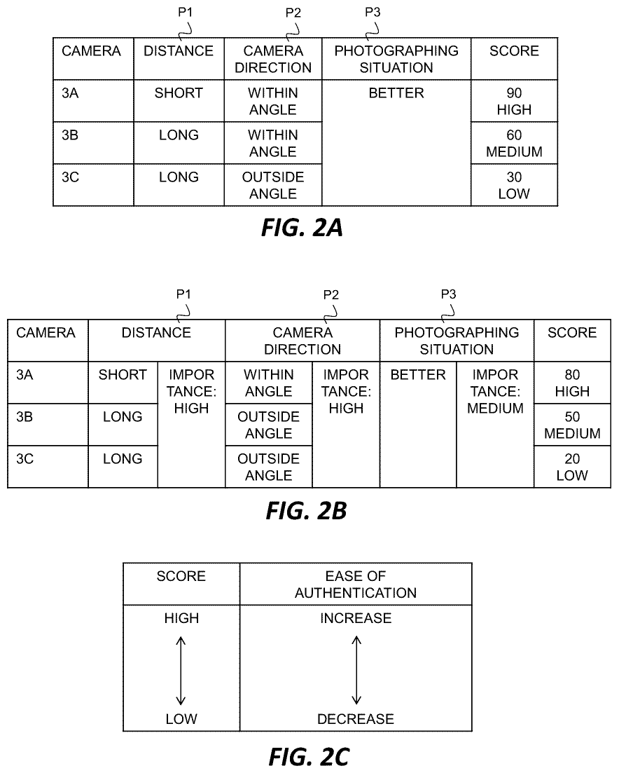

FIG. 2A, FIG. 2B, and FIG. 2C are diagrams for explaining a specific example of selection of a target camera. In the example illustrated in FIG. 2A, FIG. 2B, and FIG. 2C, the ease of authentication of the moving body 4 is represented by an “evaluation score”. The evaluation score is calculated based on various parameters that affect the ease of authentication of the moving body 4. The various parameters that affect the ease of authentication of the moving body 4 include, for example, a first parameter P1, a second parameter P2, and a third parameter P3. The first parameter P1 is the length between the moving body 4 to be authenticated and the camera 3. The second parameter P2 is a relationship between the position of the moving body 4 and the orientation of the camera 3, and indicates whether the moving body 4 to be authenticated exists within the angle of view of the camera 3. The third parameter P3 indicates the photographing situation when the camera 3 photographs the moving body 4 to be authenticated.

An example of calculating the evaluation value of each parameter will be described. In the calculation of the first parameter P1, the management server 10 calculates distances between the moving body 4 and the cameras 3 based on the information on the positions of the plurality of cameras 3 included in the camera information 31 and the position information 32 of the moving body 4. The management server 10 sets the first parameter P1 to be higher as the distances are shorter. For example, the management server 10 determines whether the distance is less than a predetermined distance. When the distances are less than the predetermined distances, that is, when the distances are short, the management server 10 sets the evaluation value of the first parameter P1 to be high. On the other hand, when the length is equal to or longer than the predetermined length, that is, when the length is long, the management server 10 sets the evaluation value of the first parameter P1 to be low. The threshold value may be set in a plurality of stages. The first parameter P1 may continuously change according to the distances.

In the calculation of the second parameter P2, the management server 10 determines whether or not a moving body 4 exists within the angle of view of each camera 3 based on the information on the orientation of each of the plurality of cameras 3 included in the camera information 31 and the position information 32 of the moving body 4. Then, management server 10 sets a high value for second parameter P2 corresponding to camera 3 for which it is determined that moving body 4 is present within the angle of view. On the other hand, management server 10 sets the value of second parameter P2 corresponding to camera 3, which has determined that moving body 4 is present outside the angle of view, to be low. That is, the value of the second parameter P2 is high when the moving body 4 to be authenticated is present within the angle of view, and is low when the moving body 4 is present outside the angle of view. The management server 10 may set the value of the second parameter P2 in accordance with the position of the moving body 4 existing within the angle of view of the camera 3. For example, the management server 10 may set the value of the second parameter P2 to be higher as the position of the moving body 4 within the angle of view of the camera 3 is closer to the center of the horizontal angle of view. Note that the camera 3 in which the moving body 4 is present outside the angle of view is not selected as the target camera, and thus the evaluation value thereof may be set to, for example, a negative value. As will be described later, when the position or the orientation of the camera 3 is variable, the position or the orientation of the camera 3 may be changed so that the moving body 4 enters the angle of view.

In the calculation of the third parameter P3, the management server 10 recognizes the imaging situation of each camera 3 based on the image of each camera 3 included in the video database DB of the camera information 31. The photographing situation includes at least one of illuminance, whether or not the image is backlit, weather, and object density in the image. Then, the management server 10 determines whether or not the photographing situation recognized for each camera 3 satisfies the photographing possible condition. When it is determined that the photographing situation satisfies the photographing possible condition, the management server 10 sets the evaluation value of the third parameter P3 corresponding to the camera 3 satisfying the photographing possible condition to be high. On the other hand, when it is determined that the photographing situation does not satisfy the photographing possible condition, the management server 10 sets the evaluation value of the third parameter P3 corresponding to the camera 3 which does not satisfy the photographing possible condition to be low. That is, the value of the third parameter P3 becomes higher as the imaging situation is better, and becomes lower as the imaging situation is worse.

The image capturing possible condition is set in consideration of at least one of the following conditions: the brightness of the image is within a predetermined range; the degree of halation of the image is small; the image has visibility to the extent that a building, a person, or the like can be detected; and the object density in the image is equal to or less than a threshold value.

An example of calculating the evaluation score based on the evaluation value for each parameter will be described. In the first calculation method, the evaluation value is the sum of evaluation values for each parameter (see FIG. 2A).

In the second calculation method, the importance of each parameter is set in advance and considered (see FIG. 2B). The importance is represented by any one of “high”, “medium”, and “low”, for example. In the example shown in FIG. 2B, the importance of the first parameter P1 and the second parameter P2 is “high”, and the importance of the third parameter P3 is “medium”. Then, the product of the evaluation value and the importance is calculated for each parameter, and the sum of the products for each parameter is calculated as the evaluation score. Alternatively, a weighted average of the evaluation values for each parameter may be calculated as the evaluation score. According to the second calculation method, the importance of each parameter is considered, and thus it is possible to appropriately calculate the evaluation score.

The higher the evaluation score, the more easily the moving body 4 is authenticated, and the lower the evaluation score, the less easily the moving body 4 is authenticated (see FIG. 2C). After calculating the evaluation score, the management server 10 selects a target camera having an evaluation score (that is, ease of authentication of the moving body 4) equal to or higher than a predetermined level. The predetermined level may be a predetermined threshold value or may be a threshold value that varies depending on the type of the moving body 4 (a human, a vehicle, an animal, or the like). For example, when the predetermined level is set to “60”, in the example illustrated in FIG. 2A, the management server 10 selects the camera 3A and the camera 3B having the predetermined level or higher as the target cameras. On the other hand, in the example illustrated in FIG. 2B, management server 10 selects camera 3A having an evaluation score equal to or higher than a predetermined level as a target camera. Note that, regardless of the evaluation score, the camera 3 in which the moving body 4 is present outside the angle of view is not selected as the target camera.

Note that, when there are a plurality of cameras 3 whose evaluation scores are equal to or higher than the predetermined level, one camera 3 may be further selected from the plurality of cameras 3. Specifically, the management server 10 may select one camera having a highest ease of authentication of the moving body 4 from among the plurality of cameras 3 as the target camera.

In this way, at least one camera 3 is selected from the plurality of cameras 3 as the target camera used for the authentication of the moving body 4. The ease of authentication (evaluation score) of the moving body 4 is used for the selection of the target camera. By selecting the camera 3 having high ease of authentication of the moving body 4 as the target camera, the moving body 4 can be authenticated with a smaller number of cameras, and thus the processing load is reduced.

### 1-3. Example of Improvement in Ease of Authentication

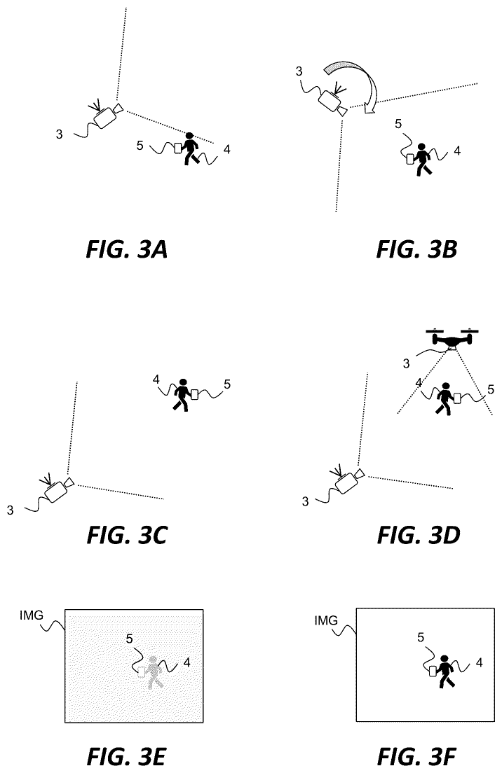

When there is no camera 3 whose ease of authentication of the moving body 4 is equal to or higher than the predetermined level, the target camera used for authentication of the moving body 4 is not selected. Therefore, the management server 10 may perform a process of actively improving the ease of authentication of the moving body 4. FIG. 3A, FIG. 3B, FIG. 3C, FIG. 3D, FIG. 3E, and FIG. 3F are diagrams for explaining a specific example of a process for improving the ease of authentication of the moving body 4. Three examples of the process of improving the ease of authentication of the moving body 4 will be described.

The first example is a case where the moving body 4 is not present within the angle of view of the camera 3 closest to the moving body 4, as shown in FIG. 3A. In this case, the ease of authentication of the moving body 4 decreases. However, the camera 3 may be a “variable orientation camera” whose orientation is variable. In this case, for example, as shown in FIG. 3B, the orientation of the camera 3 may be changed so that the moving body 4 is present within the angle of view of the camera 3 (orientation variable camera). Even when the orientation of the camera 3 closest to the moving body 4 is fixed, if the plurality of cameras 3 include a orientation variable camera, the orientation of the orientation variable camera may be changed so that the moving body 4 is present within the angle of view of the orientation variable camera.

According to the first example, the management server 10 calculates an angle by which the orientation variable camera is rotated so that the orientation of the orientation variable camera is aligned with the position of the moving body 4, based on the information of the orientation of the orientation variable camera included in the camera information 31 and the position information 32 of the moving body 4. Then, the management server 10 transmits rotation instruction information for instructing the camera to rotate based on the calculated angle to the camera via the communication device 40. Thus, the moving body 4 is present within the angle of view of the orientation variable camera, and the ease of authentication of the moving body 4 is improved. When the ease of authentication of the moving body 4 in the orientation variable camera is equal to or higher than a predetermined level, the orientation variable camera is selected as the target camera.

The second example is a case where the distance from the camera 3 whose position is fixed to the moving body 4 is long as shown in FIG. 3C. In this case, the moving body 4 included in the image captured by the camera 3 becomes unclear, and the ease of authentication of the moving body 4 decreases. However, a case where a “position variable camera” whose position is variable can be used is also considered. Examples of the position variable camera include an in-vehicle camera and a camera mounted on a drone. When the position variable camera is available, the position of the position variable camera may be changed so that the moving body 4 is present within the angle of view of the position variable camera as illustrated in FIG. 3D. When there are a plurality of position variable cameras, the position of the position variable camera closest to the moving body 4 may be changed.

According to the second example, the management server 10 transmits information of a movement instruction to the position variable camera via the communication device 40 so that the position of the position variable camera approaches the position of the moving body 4 based on the information of the position of the position variable camera included in the camera information 31 and the position information 32 of the moving body 4. This makes it possible to photograph the moving body 4 from a close distance, and the ease of authentication of the moving body 4 is improved. When the ease of authentication of the moving body 4 in the variable camera is equal to or higher than a predetermined level, the variable position camera is selected as the target camera.

The second example can also be applied to the situation shown in FIG. 3A. In this case, the management server 10 transmits a movement instruction to the position variable camera so that the moving body 4 is included in the angle of view of the position variable camera. Thus, the moving body 4 is present within the angle of view of the variable position camera, and the ease of authentication of the moving body 4 is improved. When the ease of authentication of the moving body 4 in the position variable camera becomes equal to or higher than a predetermined level, the position variable camera is selected as the target camera.

As described in the first and second examples, the ease of authentication of the moving body 4 can be improved by changing at least one of the camera position and the camera orientation of the variable camera.

The third example is a case where a moving body 4 exists in the angle of view of the camera 3 closest to the moving body 4 and the image quality of the image IMG captured by the camera 3 is low, as illustrated in FIG. 3E. For example, the image quality of the image IMG captured in a dark environment or a backlight environment is low. In this case, the moving body 4 included in the image captured by the camera 3 becomes unclear, and the ease of authentication of the moving body 4 decreases. In this case, the management server 10 may improve the image quality of the image IMG so that the ease of authentication of the moving body 4 increases. For example, as shown in FIG. 3F, the image quality of the image IMG can be improved by performing the brightness correction processing. Thus, the moving body 4 to be authenticated included in the image IMG becomes clear, and the ease of authentication of the moving body 4 is improved.

### 1-4. Processing Flow Example

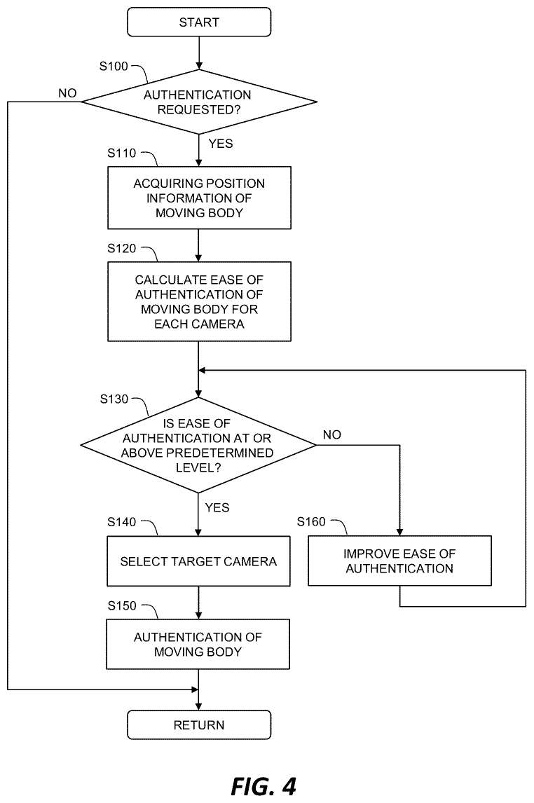

FIG. 4 is a flowchart summarizing an example of the moving body authentication process according to the first embodiment.

In step S100, the management server 10 determines whether or not a request for authenticating the moving body 4 has been received. When the request for authenticating the moving body 4 is received (step S100; Yes), the process proceeds to step S110. Otherwise (step S100; No), the process is terminated.

In step S110, the management server 10 acquires the position information 32 of the moving body 4. Thereafter, the process proceeds to step S120.

In step S120, management server 10 calculates the ease of authentication of moving body 4 for each camera 3. Thereafter, the process proceeds to step S130.

In step S130, the management server 10 determines whether or not the ease of authentication of the moving body 4 is equal to or higher than a predetermined level. When the ease of authentication of the moving body 4 is equal to or higher than the predetermined level (Yes in step S130), the process proceeds to step S140. Otherwise (No in step S130), the process proceeds to step S160.

In step S140, the management server 10 selects, as a target camera, a camera 3 whose ease of authentication of the moving body 4 is equal to or higher than a predetermined level. Thereafter, the process proceeds to step S150.

In step S150, the management server 10 authenticates the moving body 4 based on comparison between the image captured by the target camera and the authentication image 33.

In step S160, the management server 10 improves the ease of authentication of the moving body 4 so that the ease of authentication of the moving body 4 is equal to or higher than a predetermined level. Thereafter, the process returns to step S130.

### 1-5. Effect

According to the first embodiment, when a request to authenticate the moving body 4 is received, the camera 3 whose ease of authenticating the moving body 4 is equal to or higher than a predetermined level is selected as the “target camera”. Then, the moving body 4 is authenticated based on the comparison between the image captured by the target camera and the authentication image 33. This allows the moving body 4 to be authenticated with a smaller number of cameras, and thus the processing load is reduced. Further, since an unnecessarily large number of images are not used for authentication, the opportunity of performing unnecessary authentication processing on a person unrelated to the moving body 4 to be authenticated is reduced. This is preferable from the viewpoint of ensuring privacy.

### 2. Second Embodiment

In the second embodiment, a method of improving the ease of authentication of the moving body 4 by positively acting on the moving body 4 to be authenticated will be described. In the second embodiment, the moving body 4 to be authenticated is a person who can respond to a request from the management server 10. The management server 10 requests the person to be authenticated to perform a predetermined action. Specifically, the management server 10 transmits instruction information for requesting the person to perform a predetermined action to the mobile terminal 5 carried by the person via the communication device 40.

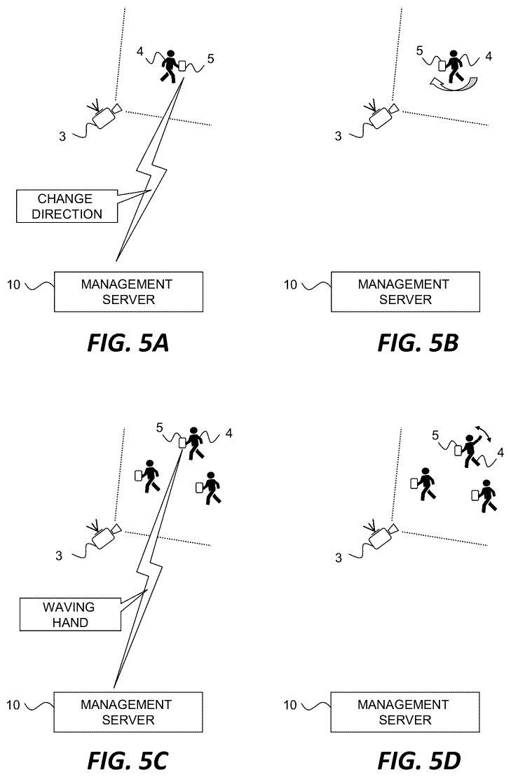

In the example shown in FIG. 5A, the face of the person to be authenticated is not seen from the camera 3, and the authentication process has failed. In this case, the management server 10 may request the person to be authenticated to change the orientation. That is, the predetermined action may be changing the orientation. As another example, when the camera 3 is installed at a nearby landmark, the management server 10 may request the person to be authenticated to face the landmark. That is, the predetermined action may be to turn toward the landmark. As shown in FIG. 5B, there is a possibility that the face of the person can be seen from the camera 3 by the person changing the orientation. As a result, the authentication process may succeed.

In the example shown in FIG. 5C, a large number of moving bodies 4 are shown in the image captured by the camera 3. In this case, the management server 10 may request the moving body 4 to perform a predetermined action so that the person to be authenticated can be easily distinguished from the other moving body 4. Examples of the predetermined action include waving a hand, jumping, and the like. As shown in FIG. 5D, the person who has received the request performs a predetermined action. The management server 10 detects an object performing a predetermined action by performing image analysis. Thereafter, the management server 10 performs authentication processing on the detected object.

In this way, by requesting the person to be authenticated to perform a predetermined action, it becomes easy to specify the person to be authenticated in the image IMG. As a result, the ease of authentication of the moving body 4 is improved. In addition, the authentication accuracy of the moving body 4 is improved.

The first embodiment and the second embodiment can be combined.

### 3. Third Embodiment

For example, a case where the density of persons who are not the authentication target is high around the moving body 4 as the authentication target is considered. In this case, the image captured by the target camera includes a person unrelated to the moving body 4 to be authenticated. In this case, unnecessary authentication processing is performed on a person who is not related to the moving body 4. This is not preferable from the viewpoint of ensuring privacy. Therefore, in the third embodiment, the area in which the moving body 4 is estimated to be shown in the image captured by the target camera is narrowed down.

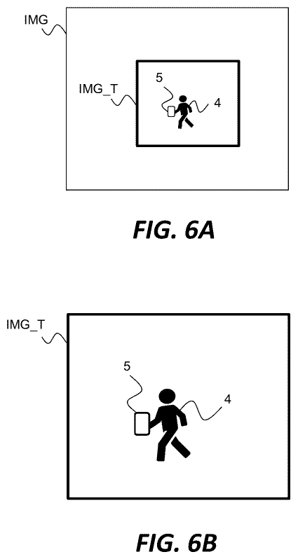

FIG. 6A and FIG. 6B are explanatory diagrams showing a specific example of the moving body authentication process according to the third embodiment. The management server 10 acquires an image IMG captured by the target camera. The position and orientation of the target camera are included in the camera information 31. The position of the moving body 4 is obtained from the position information 32. Therefore, the management server 10 can narrow down the area in which the moving body 4 to be authenticated is estimated to be shown in the image IMG based on the camera information 31 and the position information 32 of the moving body 4. The image IMG of the narrowed region is referred to as a partial region image IMG_T. The range of the partial region image IMG_T is smaller than the range of the original image IMG. In the example shown in FIG. 6A, the management server 10 trims the partial region image IMG_T from the original image IMG. Then, the management server 10 performs authentication of the moving body 4 based on comparison between the partial region image IMG_T and the authentication image 33 of the moving body 4.

In the example shown in FIG. 6B, the management server 10 instructions the target camera to zoom in on the area where the moving body 4 to be authenticated is estimated to be shown. As described above, the region in which the moving body 4 is estimated to be shown in the original image IMG can be estimated based on the camera information 31 and the position information 32 of the moving body 4. The management server 10 acquires the zoomed-in image as the partial region image IMG_T from the target camera. Then, the management server 10 performs authentication of the moving body 4 based on comparison between the partial region image IMG_T and the authentication image 33 of the moving body 4.

According to the third embodiment, the image IMG captured by the target camera is narrowed to the partial region image IMG_T in which the moving body 4 to be authenticated is estimated to be shown. Then, the moving body 4 is authenticated based on the comparison between the partial region image IMG_T and the authentication image 33. Compared to the case of the original image IMG, the probability that a person unrelated to the moving body 4 to be authenticated is shown in the partial region image IMG_T is greatly reduced. Therefore, the opportunity of performing unnecessary authentication processing on a person who is not related to the moving body 4 to be authenticated is reduced. This is preferable from the viewpoint of ensuring privacy. Further, by using the partial region image IMG_T, the moving body 4 can be more easily specified, and thus the authentication accuracy of the moving body 4 is improved.

The first embodiment and the third embodiment, or the second embodiment and the third embodiment can be combined.

What is claimed is:

1. A moving body authentication system for authenticating a moving body in a predetermined area,
the moving body authentication system comprising:
processing circuitry configured to communicate with a plurality of cameras existing in the predetermined area; and
one or more memories configured to store an authentication image of the moving body and camera information indicating at least a position and an orientation of each of the plurality of cameras, wherein
ease of authentication of the moving body depends on at least a distance between the moving body and a camera, and increases as the distance becomes shorter, and
when receiving a request for authenticating the moving body, the processing circuitry is further configured to:
acquire position information indicating a current position of the moving body;
select a target camera having the ease of authentication equal to or higher than a predetermined level from the plurality of cameras based on at least the position information and the camera information; and
authenticate the moving body based on a comparison between an image captured by the target camera and the authentication image.

2. The moving body authentication system according to claim 1, wherein
the processing circuity is further configured to select a camera closest to the moving body among the plurality of cameras as the target camera, or to select one having a highest ease of authentication among the plurality of cameras as the target camera, based on the position information and the camera information.

3. The moving body authentication system according to claim 1, wherein
the plurality of cameras includes a variable camera in which at least one of a camera position and a camera orientation is variable, and
the processing circuitry is further configured to:
change at least one of the camera position and the camera orientation of the variable camera so that the ease of authentication regarding the variable camera increases; and
select the target camera having the ease of authentication equal to or higher than the predetermined level in consideration of a change in the at least one of the camera position and the camera orientation of the variable camera.

4. The moving body authentication system according to claim 1, wherein
the moving body is a human, and
the processing circuitry is further configured to require the human to perform a predetermined action.

5. The moving body authentication system according to claim 1, wherein
the processing circuitry is further configured to:
narrow the image to a partial region image in which the moving body is estimated to be shown, based on the position information and the camera information; and
authenticate the moving body based on a comparison between the partial region image and the authentication image.
